(19) United States
(12) Patent Application Publication
(10) Pub. No.: US 2026/0020536 A1
(43) Pub. Date: Jan. 22, 2026

(54) INTEGRATED SYSTEM AND METHOD FOR WATER-ADAPTIVE AGRICULTURAL IRRIGATION IN ARID REGIONS

(71) Applicant: Nanjing Hydraulic Research Institute, Nanjing (CN)

(72) Inventors: Xiaojun Wang, Nanjing (CN); Feng Chen, Nanjing (CN); Jianyun Zhang, Nanjing (CN); Rui Zou, Nanjing (CN); Tao Zhang, Nanjing (CN)

(21) Appl. No.: 19/273,194

(22) Filed: Jul. 18, 2025

(30) Foreign Application Priority Data
Jul. 19, 2024 (CN) 202410971141.1

(51) Int. Cl. A01G 25/16; C02F 1/00; C02F 103/00; C02F 103/06

(52) U.S. Cl. CPC A01G 25/165; C02F 1/004; C02F 2103/001; C02F 2103/06; C02F 2201/005; C02F 2209/40; C02F 2209/42

(57) ABSTRACT

An integrated system for water-adaptive agricultural irrigation in arid regions, including a water storage well, at least one open ditch and at least one subsurface ditch, where a water storage chamber for storing water is provided over the water storage well, the at least one open ditch is connected to the water storage well and located on ground surface, the at least one subsurface ditch is connected to the water storage well and located in soil at a certain distance from the ground surface; the at least one open ditch and the at least one subsurface ditch are each provided with a first control valve at an end close to the water storage well. An integrated method for water-adaptive agricultural irrigation in arid regions, including regulating an irrigation based on comprehensive consideration of available water supply quantity, growth stages of local crops and critical water requirement thresholds.

### CROSS-REFERENCE TO RELATED APPLICATION

This disclosure claims the benefit of Chinese patent application No. 202410971141.1, filed on Jul. 19, 2024, which is incorporated herein by reference in its entirety.

### TECHNICAL FIELD

This disclosure relates to the technical field of water conservancy engineering, and in particular to an integrated system and method for water-adaptive agricultural irrigation in arid regions.

### BACKGROUND

Agricultural water consumption accounts for 60% or more of total water consumption. China's water shortage problem has been solved mainly by water-saving irrigation technology for a long time, including canal seepage control, low-pressure conduit transmittal water irrigation, micro-irrigation, sprinkling irrigation and other innovative water-saving irrigation projects. Irrigation generally involves the following steps: obtaining water from water sources and delivering the water to fields through a water conveyance system; converting the water into soil water through irrigation; then converting the soil water into biowater by crops to promote the growth of crops. The conversion from the water to the soil water has currently become the focal point of saving irrigation research. Nowadays, irrigation water is not sufficiently systematically recycled, and the regional irrigation-drainage allocation does not match the crop water requirement, resulting in serious waste of water resources in the agricultural production process. In view of the above problems, it is urgently necessary to propose a systematic method to achieve recycling of water and efficient water saving.

### SUMMARY

This disclosure provides an integrated system and method for water-adaptive agricultural irrigation in arid regions, to solve the existing problems in the prior art, such as the low degree of systematic recycling of irrigation water and the mismatch between the regional irrigation-drainage allocation and the crop water requirement.

In a first aspect, provided herein is an integrated system for water-adaptive agricultural irrigation in arid regions, comprising:
a water storage well, provided with a water storage chamber for storing water;
at least one open ditch, connected to the water storage well and located on ground surface;
at least one subsurface ditch, connected to the water storage well and located in soil at a certain distance from the ground surface,
wherein a first control valve is provided at an end of each of the at least one open ditch and the at least one subsurface ditch close to the water storage well.

Preferably, the integrated system for water-adaptive agricultural irrigation in arid regions further comprises a covering layer disposed around the water storage well and the at least one open ditch, and the covering layer is a biological material covering the ground surface.

Preferably, the at least one open ditch and the at least one subsurface ditch are each provided with a flow meter which is configured to monitor flow velocity and water volume in the at least one open ditch or the at least one subsurface ditch.

Preferably, the integrated system for water-adaptive agricultural irrigation in arid regions further comprises:
a filter pool, disposed around the water storage well and configured to treat collected water; wherein both the at least one open ditch and the at least one subsurface ditch are connected to the water storage well via the filter pool, and a filter chamber is provided in the filter pool;
a water level measurement assembly, located in the water storage well;
a spraying assembly, located at one side of the filter pool and connected to the filter pool, wherein the spraying assembly is configured to spray a treating agent into the filter chamber;
an inflation/suction assembly, located at one side of the filter pool, wherein one end of the inflation/suction assembly passes through the filter pool and extends into the filter chamber, and the inflation/suction assembly is configured to inflate gas into the filter pool or suction a sediment from the filter pool; and
a drainage ditch, connected to the filter pool at one end and connected to a river channel at the other end.

Preferably, a second control valve is provided between the filter pool and the drainage ditch, a third control valve is provided between the filter pool and the water storage well;
a water quality detector is provided inside the filter pool, and the water quality detector is electrically connected to the second control valve, the third control valve and the water level measurement assembly simultaneously.

In a second aspect, provided herein is an integrated method for water-adaptive agricultural irrigation in arid regions, which is performed by applying the integrated systems for water-adaptive agricultural irrigation in arid regions according to any one of the above paragraphs, comprising:
step 1: collecting water meeting irrigation water quality requirements from a water source within a regional scope, and storing the water in the at least one subsurface ditch and the water storage well, wherein the water source comprises: conventional irrigation water sources selected from surface water and underground water, unconventional water sources selected from rainwater, reclaimed water and mine water, as well as infiltrated irrigation water, drainage water or a mixed water source; and
step 2: taking a critical water requirement threshold during crop growth as a control indicator, monitoring weather, soil and crop growth conditions in real time, and regulating an irrigation based on comprehensive consideration of available water supply, a growth stage of crops and the critical water requirement threshold.

Preferably, the irrigation in step 2 is regulated in three modes, including a water requirement mode, a suitable water mode and a drainage mode, wherein the irrigation is regulated through a method comprising the following steps:
step 2.1: monitoring available water supply quantity, Q_{supply}, in the water storage well and the at least one subsurface ditch in real time and determining a relationship between the available water supply quantity and a minimum water requirement quantity, Qₘᵢₙ, and a maximum water requirement quantity, Qₘₐₓ, during crop growth, and
in a case of Q_{supply}<Qₘᵢₙ indicating a water requirement state of the integrated system, regulating the irrigation in the water requirement mode so that external water is supplemented into the water storage well and the at least one subsurface ditch, and irrigating crops with water collected and supplemented in the water storage well and the at least one subsurface ditch timely, wherein Qₛᵤₚₚₗₑₘₑₙₜ is calculated according to Equation 1:

$${Q}_{supplement} = {Q}_{irrigation} - {Q}_{supply} \qquad ( Equation 1 )$$

wherein Qₛᵤₚₚₗₑₘₑₙₜ represents a water quantity to be supplemented, and Q_{irrigation} represents an irrigation water quantity required at the growth stage of crops;
step 2.2: continuously monitoring the available water supply quantity and determining the relationship between the available water supply quantity and the minimum water requirement quantity and the maximum water requirement quantity during the crop growth period, continuously supplementing the external water until Qₘᵢₙ<Q_{supply}<Qₘₐₓ which indicates a suitable water state of the integrated system, regulating the irrigation in the suitable water mode, and irrigating the crops with water collected in the water storage well and the at least one subsurface ditch, without the external water supplemented; and
step 2.3: conducting cyclic irrigation in the suitable water mode, and determining a state of the integrated system in next cycle by monitoring the available water supply quantity Q_{supply}, Q_{storage}, and the growth stage of crops in real time;
in a case of Q_{supply}>Qₘₐₓ and Q_{storage}>Qᵥ indicating a drainage state of the integrated system, regulating the irrigation in the drainage mode so that excess water is drained into a river after treatment,
in a case of the suitable water state of the integrated system, regulating the irrigation in the suitable water mode, and
in a case of the water requirement state of the integrated system, regulating the irrigation in the water requirement mode,
wherein Q_{storage} represents a water quantity stored in the integrated system, and Qᵥ represents a designed volume of the at least one subsurface ditch and the water storage well.

Preferably, in step 2.3,

$${Q}_{storage} = {Q}_{rain} + {Q}_{reclaimed} + {Q}_{mine} + {Q}_{infiltration} + {Q}_{supplement} - {Q}_{actual evapotranspiration of crops} - {Q}_{loss} \leq Qv \qquad ( Equation 2 )$$

wherein, Qᵣₐᵢₙ represents a stored rainwater quantity, Q_{reclaimed} represents a supplied reclaimed water quantity, Qₘᵢₙₑ represents a supplied mine water quantity, Q_{infiltration} represents a water quantity infiltrated into the at least one subsurface ditch and the water storage well after irrigation, Qₛᵤₚₚₗₑₘₑₙₜ represents a water quantity supplemented from the conventional irrigation water sources, and Q _{actual evapotranspiration of crops} represents actual evapotranspiration of crops, Qₗₒₛₛ represents a water quantity lost during transportation and infiltration, and Qv represents the designed volume of the at least one subsurface ditch and the water storage well.

Preferably, the irrigation water quantity, Q_{irrigation}, in step 2.1 is calculated according to Equation 3:

$${Q}_{irrigation} = \{ \begin{matrix}{Q}_{min} + {Q}_{loss} {Q}_{supply} < {Q}_{min} \\ {Q}_{supply} + {Q}_{loss} {Q}_{min} < {Q}_{supply} < {Q}_{max} \\ ( {Q}_{min} + {Q}_{loss} , {Q}_{max} + {Q}_{loss} ) {Q}_{max} < {Q}_{loss}\end{matrix} \qquad ( Equation 3 )$$

wherein, Q_{supply} represents the available water supply quantity in the water storage well and the at least one subsurface ditch, Qₘᵢₙ and Qₘₐₓ represent the minimum water requirement quantity and maximum water requirement quantity during the crop growth period respectively, and Qₗₒₛₛ represents the water quantity lost during transportation and infiltration.

Preferably, the water quantity to be supplemented from the conventional irrigation water source, Qₛᵤₚₚₗₑₘₑₙₜ, is calculated according to the following equations:

$${Q}_{supplement} = max ( {Q}_{estimated crop water requirement} + {Q}_{loss} - {Q}_{storage} , 0 ) \qquad ( Equation 4 )$$

wherein Q_{storage} represents the water quantity stored in the integrated system, Q _{estimated crop water requirement} represents an estimated water quantity required for the crop growth period, and Qₗₒₛₛ represents the water quantity lost during transportation and infiltration;

$$when {Q}_{estimated crop water requirement} + {Q}_{loss} < {Q}_{storage} , {Q}_{supplement} = 0 \qquad ( Equation 5 )$$

during regulation of the irrigation, water source utilization efficiency, η, is calculated according to Equation 6:

$$η = {Q}_{infiltration} / {Q}_{irrigation} \times 100 \% \qquad ( Equation 6 )$$

wherein Q_{infiltration} represents a water quantity infiltrated into the at least one subsurface ditch and the water storage well after irrigation, and Q_{irrigation} represents the irrigation water quantity.

Based on the concept of efficient and circular utilization of multiple water sources such as precipitation, irrigation water, surface water, underground water, rainwater, reclaimed water and mine water, this disclosure provides an integrated system for water-adaptive agricultural irrigation in arid regions, which is constructed by combining infiltration of rainwater (irrigation water) in arid regions with recycling of water in soil-storage of shallow underground water. With the integrated system, multiple water sources (for example, conventional irrigation water sources such as surface water, underground water, unconventional irrigation water sources such as rainwater, reclaimed water and mine water, as well as infiltrated irrigation water, drainage water or a mixed water source) are introduced for internal circulation, maximizing the recycling and utilization of existing water sources. The flow meters and first control valves are provided to collect and monitor data of flow velocity and water volume, thereby forming an integrated system of water storage, irrigation and water drainage, including irrigation at the top-infiltration in the middle-collection and storage at the bottom, which can achieve real-time monitoring and regulation. This disclosure also provides an integrated method for water-adaptive agricultural irrigation in arid regions. In the integrated method, based on the crop water requirement quantity at different growth stages, irrigation is rationally regulated, thereby solving the existing problems in the art, such as a low degree of systematic recycling of irrigation water and the mismatch between the regional irrigation-drainage allocation and the crop water requirement quantity. The method has a remarkable effect and is suitable for wide applications.

### BRIEF DESCRIPTION OF THE DRAWINGS

To illustrate the technical solutions of the embodiments of this disclosure more clearly, this disclosure will be described with reference to the drawings in conjunction with the embodiments. It is obvious that the drawings described below are merely some embodiments of this disclosure. Those skilled in the art can obtain other drawings based on these drawings without making creative efforts.

FIG. 1 is a structural schematic diagram of an integrated system for water-adaptive agricultural irrigation in arid regions according to an embodiment of the disclosure;

FIG. 2 is a flowchart schematically showing an integrated method for water-adaptive agricultural irrigation in arid regions according to an embodiment of the disclosure; and

FIG. 3 is a structural schematic diagram of another integrated system for water-adaptive agricultural irrigation in arid regions according to a further embodiment of the disclosure.

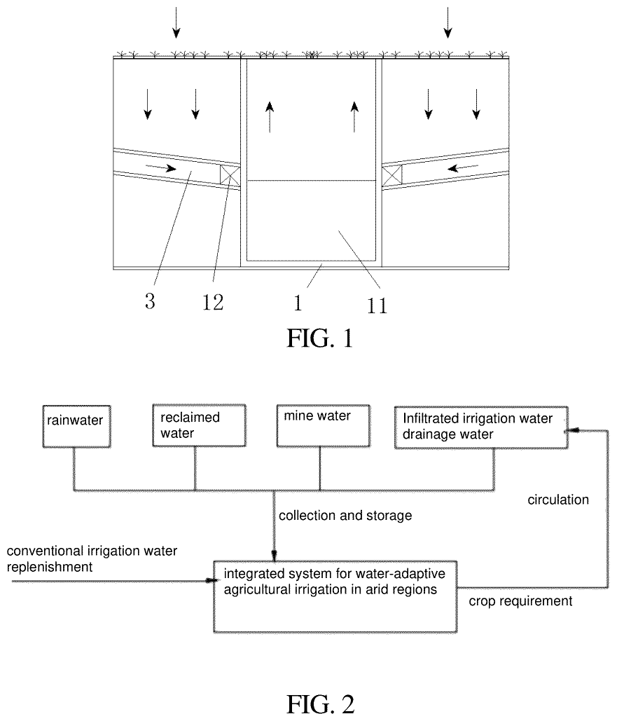

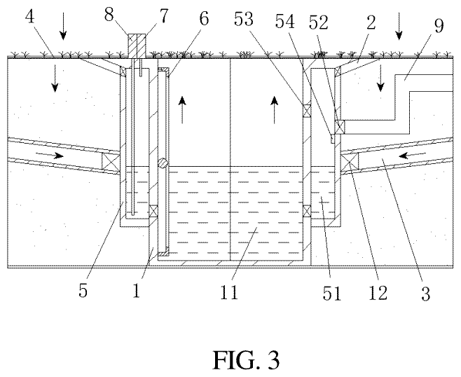

In FIGS. 1-3:
1. water storage well; 2. open ditch 3. subsurface ditch; 4. covering layer; 5. filter pool; 6. water level measurement assembly; 7. spraying assembly; 8. inflation/suction assembly; 9. drainage ditch; 11. water storage chamber; 12. first control valve; 51. filter chamber; 52. second control valve; 53. third control valve; 54. water quality detector.

### DETAILED DESCRIPTION

The technical solutions in the embodiments of this disclosure will be clearly and completely described below in combination with the drawings. Obviously, the described embodiments are only part of the embodiments of this disclosure, not all of them. All other embodiments obtained by those skilled in the art based on the embodiments of this disclosure without making creative efforts also fall within the protection scope of this disclosure.

An embodiment of the integrated system for water-adaptive agricultural irrigation in arid regions provided herein is described below by referring to FIGS. 1-3. The integrated system for water-adaptive agricultural irrigation in arid regions comprises a water storage well 1, at least one open ditch 2 and at least one subsurface ditch 3. The water storage well 1 is provided with a water storage chamber 11 for storing water, the at least one open ditch 2 is connected to the water storage well 1 and located on ground surface, the at least one subsurface ditch 3 is connected to the water storage well 1 and located in soil at a certain distance from the ground surface, and a first control valve 12 is provided at an end of each of the at least one open ditch 2 and the at least one subsurface ditch 3 close to the water storage well 1.

The term “storage” means the storage of rainwater, infiltrated irrigation water, and supplemented water in the at least one subsurface ditch 3 and the water storage well 1. The term “irrigation” means the irrigation is regulated based on comprehensive consideration of the growth stages of crops, a threshold indicator and an available water supply quantity, transforming from single-objective efficient water conservation to an integrated approach of saving water, fertilizer and pesticide, without focusing solely on water conservation as the sole indicator. The term “drainage” means reducing rainwater discharge during heavy summer precipitation to increase underground water storage; or using traditional irrigation methods when water is relatively abundant and collecting the drainage water in a case where farmland drainage exists to increase the internal recycling frequency.

In this embodiment, the water storage well 1 and the at least one subsurface ditch 3 are arranged based on local topography, landforms and climate conditions, in accordance with the growth stages and water requirement characteristics of crops planted in the farmland. The assemblies for monitoring water level and water quality, as well as water pumps for irrigation arc arranged in the water storage well 1. The water pumps, and the assemblies for monitoring water level and water quality are well known in the art and will not be elaborated further here, and any assembly that can achieve the corresponding function is within the protection scope of this disclosure. The integrated system also comprises a covering layer 4 located around the water storage well I and the at least one open ditch 2. The covering layer 4 is a biological material covering the ground surface. For example, the covering layer 4 can be a layer of an ecological material such as straw, achieving the objective of reducing water evaporation, collecting water vapor in the air near the ground surface and increasing the moisture content of the surface soil. Flow meters are set in both the at least one open ditch 2 and the at least one subsurface ditch 3. The flow meters are configured to monitor the flow velocity and water volume in the at least one open ditch 2 and the at least one subsurface ditch 3. The at least one open ditch 2 can serve as an irrigation ditch. A water-resisting layer is also set up at a certain depth of 5 to 6 meters below the ground surface to prevent water from further infiltration.

In this embodiment, a root system of corn is generally 80-100 cm in length; a root system of wheat is 50-80 cm in length, with a maximum length of 3 m; a root system of cotton is generally 1.5-3 m in length, with a maximum length of 5-6 m; a main root system of a sunflower is generally 100-200 cm in length; and a root system of crops in arid regions may be longer. Considering the economic feasibility of engineering construction and the reduced impact of water evaporation, the water storage well 1 and the at least one subsurface ditch 3 can be located in a farmland at a depth of 50-250 cm below the ground surface. The at least one subsurface ditch 3 and the water storage well 1 are arranged in the farmland (for example, the at least one subsurface ditch 3 and the water storage well 1 are located at a depth of 50-250 cm below the ground surface) according to the lengths of root systems of different crops, to collect and store the rainwater and infiltrated irrigation water. The volumes of the at least one subsurface ditch 3 and the water storage well I are determined under comprehensive consideration of control area, local precipitation, irrigation water quantity and water source status.

Compared with the prior art, the integrated system for water-adaptive agricultural irrigation in arid regions is based on the concept of efficient and circular utilization of multiple water sources such as precipitation, irrigation water, surface water, groundwater, rainwater, reclaimed water and mine water. The system is constructed by infiltration of rainwater (irrigation water) in arid regions-recycling of water in soil-storage of shallow groundwater, wherein multiple water sources (for example, conventional irrigation water sources such as surface water, groundwater; unconventional irrigation water sources such as rainwater, reclaimed water and mine water; as well as infiltrating of irrigation water, drainage water or a mixed water source) are introduced for internal circulation, maximizing the recycling and utilization of existing water sources. The assemblies such as flow meters and first control valves 12 are provided to collect and monitor data such as flow velocity and water volume, thereby forming an integrated structure of water storage, irrigation and drainage with real-time monitoring and regulation functions, namely irrigation at the top-infiltration in the middle-collection and storage at the bottom.

In another embodiment of this disclosure, the integrated system for water-adaptive agricultural irrigation in arid regions is similar to that in the above embodiment in structure, and the difference lies in that the system in this embodiment also comprises a filter pool 5, a water level measurement assembly 6, a spray assembly 7, an inflation/suction assembly 8, and a drainage ditch 9, wherein the filter pool 5 is disposed around the water storage well 1 and configured to treat collected water; wherein both the at least one open ditch 2 and the at least one subsurface ditch 3 are connected to the water storage well 1 via the filter pool 5, and a filter chamber 51 is provided in the filter pool 5; the water level measurement assembly 6 is located in the water storage well 1; the spraying assembly 7 is located at one side of the filter pool 5 and connected to the filter pool 5, wherein the spraying assembly 7 is configured to spray a treating agent into the filter chamber 51; the inflation/suction assembly 8 is located at one side of the filter pool 5, wherein one end of the inflation/suction assembly 8 passes through the filter pool 5 and extends into the filter chamber 51, and the inflation/suction assembly 8 is configured to inflate gas into the filter pool 5 or suction a sediment from the filter pool 5; and the drainage ditch 9 is connected to the filter pool 5 at one end and connected to a river channel at the other end.

In this embodiment, a second control valve 52 is provided between the filter pool 5 and the drainage ditch 9, a third control valve 53 is provided between the filter pool 5 and the water storage well 1; a water quality detector 54 is provided inside the filter pool 5, and the water quality detector 54 is electrically connected to the second control valve 52, the third control valve 53 and the water level measurement assembly 6 simultaneously. A check valve is provided between the filter pool 5 and the water storage well 1. The collected water is treated in the filter pool 5, then flows into the water storage well 1 through the check valve for storage.

When it is detected by the water level measurement assembly 6 that the stored water is excessive and needs to be discharged, the check valve is closed and the third control valve 53 is open. The water in the water storage well 1 flows into the filter pool 5 through the third control valve 53. The spraying assembly 7 sprays an agent for treating water into the filter chamber 51, and the inflation/suction assembly 8 inflates gas into the filter chamber 51 to mix the water to be discharged with the agent. When it is detected by the water quality detector 54 that the water quality of water in the filter pool 5 meets the discharge standards, the second control valve 52 is open so that treated water is discharged into a river channel. A drainage pump is provided between the drainage ditch 9 and the filter pool 5, and configured to suction the water from the filter pool 5 and push the water to be discharged as soon as possible. All assemblies, as long as they can achieve the relevant performance functions of the water quality detector 54, the second control valve 52, the third control valve 53 and the first control valve 12, are within the protection scope of this disclosure.

In this embodiment, the spraying assembly 7 comprises a spray head and an agent storage box. The agent storage box is located on the ground surface and is configured for storing the agent. One end of the spray head is connected to the drug storage box, and the other end of the spray head passes through the filter pool 5 and extends into the filter chamber 51 for spraying the agent into the filter chamber 51. A fourth control valve for controlling an on-off state is provided between the spray head and the agent storage box. This integrated system further comprises a controller, and the controller is electrically connected to the water level measurement assembly 6, the spraying assembly 7, the inflation/suction assembly 8, the second control valve 52, the third control valve 53, the first control valve 12, the water quality detector 54, and the check valve simultaneously, for controlling opening and closing of the respective assemblies in different working modes.

In this embodiment, the inflation/suction assembly 8 may comprise an inflation/suction pipe, an inflation/suction pump, and a recycling box. The inflation/suction pipe passes through the filter pool 5 and extends to the bottom of the filter chamber 51. The inflation/suction pump is configured for gas inflation or sediment suction. The recycling box is located between the inflation/suction pipe and the inflation/suction pump, and is configured to collect sediments and other wastes. When there is no need to discharge water, the inflation/suction assembly 8 suctions sediments produced during filtration or water treatment from the filter pool 5. When the infiltration water is collected, both the spraying assembly 7 and the inflation/suction assembly 8 are closed. The water collected in the open ditch 2 and the subsurface ditch 3 directly enters the filter pool 5 for sedimentation and filtration. The bottom of the filter pool 5 can be provided with a filter screen and other filtration assemblies. The filtered water flows into the water storage well 1 through the check valve for storage.

In this embodiment, the water level measurement assembly 6 comprises a limit groove, a float ball and a distance sensor. The limit groove is located vertically in the water storage well 1, and a connecting hole is provided on the limit groove for connecting to the water storage chamber 11. The float ball is provided in the limit groove and is slidably attached to the limit groove. The float ball floats up and down under the buoyancy of water, the float ball is clamped in the connecting hole to limit a movement range of the float ball and ensure that the float ball slides up and down along the limit groove. The distance sensor is connected to the limit groove and electrically connected to the float ball. The distance sensor is located at one end of the limit groove to detect the distance between the limit groove and the float ball, thereby monitoring the water level in the water storage well 1.

An embodiment of the integrated method for water-adaptive agricultural irrigation in arid regions provided herein is described below by referring to FIGS. 1-3. The integrated method for water-adaptive agricultural irrigation in arid regions is performed by applying the integrated systems for water-adaptive agricultural irrigation in arid regions, and comprises:
step 1, collection and storage: collecting water meeting irrigation water quality requirements from a water source within a regional scope, and storing the water in the at least one subsurface ditch and the water storage well, wherein the water source comprises: conventional irrigation water sources selected from surface water and underground water, unconventional water sources selected from rainwater, reclaimed water and mine water, as well as infiltrated irrigation water, drainage water or a mixed water source; and
step 2, irrigation regulation: taking a critical water requirement threshold during a crop growth process as a control indicator, based on the processes of water movement in farmland, improving an efficiency of water utilization by broadening water sources (for example, conventional irrigation water sources such as surface water, groundwater; unconventional irrigation water sources such as rainwater, reclaimed water and mine water; as well as infiltrated irrigation water, drainage water or a mixed water source), reducing water loss during movement (such as reducing water evaporation by setting a covering layer on the ground surface), and implementing water collection and recycling (such as collecting rainwater, drainage water and storing them in the water storage well 1 and at least one subsurface ditch 3), monitoring weather, soil and crop growth conditions in real time, and regulating an irrigation based on comprehensive consideration of available water supply, a growth stage of crops and the critical water requirement threshold.

In step S1, the water sources for water collection and storage comprise conventional irrigation water sources such as surface water and groundwater; unconventional water sources such as rainwater, reclaimed water and mine water, as well as infiltrated irrigation water, drainage water or a mixed water source; an on-site storage is realized, and the water is utilized in a closed-loop manner within the integrated system for water-adaptive agricultural irrigation in arid regions.

The water quantity stored in the integrated system is calculated according to Equation 2:

$${Q}_{storage} = {Q}_{rain} + {Q}_{reclaimed} + {Q}_{mine} + {Q}_{infiltration} + {Q}_{supplement} - {Q}_{actual evapotanspiration of crops} - {Q}_{loss} \leq {Q}_{V} , \qquad Equation 2$$

wherein, Qᵣₐᵢₙ represents a stored rainwater quantity, Q_{reclaimed} represents a supplied reclaimed water quantity, Qₘᵢₙₑ represents a supplied mine water quantity, Q_{infiltration} represents a water quantity infiltrated into the at least one subsurface ditch and the water storage well after irrigation, Qₛᵤₚₚₗₑₘₑₙₜ represents a water quantity supplemented from the conventional irrigation water sources, and Q_{actual evapotranspiration of crops} represents actual evapotranspiration of crops, Qₗₒₛₛ represents a water quantity lost during transportation and infiltration, and Qᵥ represents a designed volume of the at least one subsurface ditch and the water storage well.

In step S2, based on the integrated system for water-adaptive agricultural irrigation in arid regions, the irrigation is regulated in three modes in response to the various situations during the growth process of crops, including a water requirement mode, a suitable water mode and a drainage mode, and the irrigating is regulated through a method comprising the following steps:
step 2.1: monitoring available water supply quantity, Q_{supply}, in the water storage well and the at least one subsurface ditch in real time and determining a relationship between the available water supply quantity and a minimum water requirement quantity, Qₘᵢₙ, and a maximum water requirement quantity, Qₘₐₓ, during crop growth, and
in a case of Q_{supply}<Qₘᵢₙ indicating a water requirement state of the integrated system, regulating the irrigation in the water requirement mode so that external water is supplemented into the water storage well and the at least one subsurface ditch, and irrigating crops with water collected and supplemented in the water storage well and the at least one subsurface ditch timely, wherein Qₛᵤₚₚₗₑₘₑₙₜ is calculated according to Equation 1:

$${Q}_{supplement} = {Q}_{irrigation} - {Q}_{supply} \qquad ( Equation 1 )$$

wherein Qₛᵤₚₚₗₑₘₑₙₜ represents a water quantity to be supplemented, and Q_{irrigation} represents an irrigation water quantity required at the growth stage of crops;
step 2.2: continuously monitoring the available water supply quantity and determining the relationship between the available water supply quantity and the minimum water requirement quantity and the maximum water requirement quantity during the crop growth period, continuously supplementing the external water until Qₘᵢₙ<Q_{supply}<Qₘₐₓ which indicates a suitable water state of the integrated system, regulating the irrigation in the suitable water mode, and irrigating the crops with water collected in the water storage well and the at least one subsurface ditch, without the external water supplemented; and
step 2.3: conducting cyclic irrigation in the suitable water mode, and determining a state of the integrated system in next cycle by monitoring the available water supply quantity Q_{supply}, Q_{storage} and the growth stage of crops in real time;
in a case of Q_{supply}>Qₘₐₓ and Q_{storage}>Qᵥ indicating a drainage state of the integrated system, regulating the irrigation in the drainage mode so that excess water is drained into a river after treatment,
in a case of the suitable water state of the integrated system, regulating the irrigation in the suitable water mode, and
in a case of the water requirement state of the integrated system, regulating the irrigation in the water requirement mode,
wherein Q_{storage} represents a water quantity stored in the integrated system, and Qᵥ represents a designed volume of the at least one subsurface ditch and the water storage well.

In step S2.2, after several cycles of irrigation—infiltration—collection and storage within the system, the irrigation is determined to enter the water requirement mode based on the monitoring of water quantity and the growth status of the crops.

In step S2.3, after several cycles of irrigation—infiltration—collection and storage within the system, the irrigation is determined to enter the suitable water mode based on the monitoring of water quantity and the growth status of the crops.

The irrigation water quantity, Q_{irrigation}, in step 2.1 is calculated according to Equation 3:

$${Q}_{irrigation} = \{ \begin{matrix}{Q}_{min} + {Q}_{loss} & {Q}_{supply} < {Q}_{min} \\ {Q}_{supply} + {Q}_{loss} & {Q}_{min} < {Q}_{supply} < {Q}_{max} \\ ( {Q}_{min} + {Q}_{loss} , {Q}_{max} + {Q}_{loss} ) & {Q}_{max} < {Q}_{loss}\end{matrix} \qquad ( Equation 3 )$$

wherein, Q_{supply} represents the available water supply quantity in the water storage well and the at least one subsurface ditch, Qₘᵢₙ and Qₘₐₓ represent the minimum water requirement quantity and maximum water requirement quantity during the crop growth period respectively, and Qₗₒₛₛ represents the water quantity lost during transportation and infiltration.

In the integrated method for water-adaptive agricultural irrigation in arid regions, water efficient utilization consists of two indicators: the quantity of supplementary conventional irrigation water and water reuse rate. The less supplementary conventional irrigation water is used and the higher the water reuse rate is, the higher the water efficient utilization is. By monitoring the quantity of supplementary conventional irrigation water and the water reuse rate over a defined period, the water utilization effectiveness can be determined. In practical application, the irrigation performed by applying the integrated system for water-adaptive agricultural irrigation in arid regions can ensure the efficient recycling of water, maintaining the irrigation efficiency while achieving a good water-saving effect. The water quantity to be supplemented from the conventional irrigation water source (Qₛᵤₚₚₗₑₘₑₙₜ) is calculated according to Equation 4:

$${Q}_{supplement} = max ( {Q}_{estimated crop water requirement} + {Q}_{loss} - {Q}_{storage} , 0 ) \qquad ( Equation 4 )$$

wherein Q_{storage} represents the water quantity stored in the integrated system, Q_{estimated crop water requirement} represents an estimated water quantity required for the crop growth period, and Qₗₒₛₛ represents the water quantity lost during transportation and infiltration;

$$when {Q}_{estimated crop water requirement} + {Q}_{loss} < {Q}_{storage} , {Q}_{supplement} = 0 \qquad ( Equation 5 )$$

during regulation of the irrigation, water source utilization efficiency, η, is calculated according to Equation 6:

$$η = {Q}_{infiltration} / {Q}_{irrigation} \times 100 \% \qquad ( Equation 6 )$$

wherein Q_{infiltration} represents a water quantity infiltrated into the at least one subsurface ditch and the water storage well after irrigation, and Q_{irrigation} represents the irrigation water quantity.

This disclosure provides an integrated system for water-adaptive agricultural irrigation in arid regions based on the carrying capacity of water resources, improving the agricultural water use efficiency and solving the problems in the prior art, such as the low degree of systematic recycling of irrigation water and the mismatch between regional irrigation and drainage allocation and the crop water requirement quantity. Based on the characteristics of water and soil resources and agricultural distribution in arid regions, the inventors strengthen the research and development of efficient water-saving technologies in agriculture under changing environments from the aspect of the whole-process recycling and utilization of agricultural water. This disclosure brings out the following beneficial effects:

Rainwater, reclaimed water, mine water and other water sources meeting the irrigation water quality requirements, as well as infiltrated irrigation water and drainage water within the regional scope are collected and stored in the subsurface ditch and the water storage well, thereby broadening the irrigation water sources and enhancing the regional water supply capacity. Irrigation is regulated based on comprehensive consideration of the available water supply, the growth stage of local crops and the critical water requirement threshold, so as to realize water recycling within the farmland, reduce the loss of fertilizers and other nutrients caused by water drainage, achieve efficient water utilization at the farmland scale, and reduce external discharge and non-point source pollution. The groundwater level near the ground surface is regulated through the irrigation—storage—drainage means of the water in the subsurface ditch 3 and the water storage well 1, so as to increase the utilization efficiency of alternative water sources, such as rainwater, reclaimed water and mine water, and enhance the regional ecological environment and microclimate. Through the regulation of irrigation, water recycling and efficient water conservation are promoted, so as to achieve scientific water allocation and precise control and ensure that the irrigation water allocation in the region matches the crop water requirement.

It should be understood that the terms “length”, “width”, “up”, “down”, “front”, “back”, “left”, “right”, “vertical”, “horizontal”, “top”, “bottom”, “inside”, “outside”, etc. indicate the orientation or positional relationship based on those shown in the drawings, and are only for the convenience of describing embodiments of this disclosure and simplifying the description, rather than indicating or suggesting that the devices or assemblies referred to must have a specific orientation, be constructed and operated in a specific orientation. Therefore, these terms should not be construed as a limitation of this disclosure.

The various embodiments in this disclosure are described in a progressive manner. Each embodiment focuses on the differences from the others. The same or similar parts among the embodiments can be referred to each other. The contents not described in detail in the embodiments of this disclosure belong to the prior art known to those skilled in the art.

The above description of the embodiments of this disclosure enables those skilled in the art to implement or use the technical solutions of this disclosure. The various modifications to these embodiments will be obvious to those skilled in the art. The general principles defined herein can be implemented in other embodiments without departing from the spirit or scope of this disclosure. Therefore, this disclosure will not be limited to the embodiments provided herein, but rather conform to the widest scope consistent with the principles and novel features disclosed herein.

What is claimed is:

1. An integrated system for water-adaptive agricultural irrigation in arid regions, comprising:
a water storage well (1), provided with a water storage chamber (11) for storing water;
at least one open ditch (2), connected to the water storage well (1) and located on ground surface;
at least one subsurface ditch (3), connected to the water storage well (1) and located in soil at a certain distance from the ground surface,
wherein a first control valve (12) is provided at an end of each of the at least one open ditch (2) and the at least one subsurface ditch (3) close to the water storage well (1).

2. The integrated system for water-adaptive agricultural irrigation in arid regions according to claim 1, further comprising a covering layer (4) disposed around the water storage well (1) and the at least one open ditch (2), and the covering layer (4) is a biological material covering the ground surface.

3. The integrated system for water-adaptive agricultural irrigation in arid regions according to claim 1, wherein the at least one open ditch (2) and the at least one subsurface ditch (3) are each provided with a flow meter, which is configured to monitor flow velocity and water volume in the at least one open ditch (2) or the at least one subsurface ditch (3).

4. The integrated system for water-adaptive agricultural irrigation in arid regions according to claim 1, further comprising:
a filter pool (5), disposed around the water storage well (1) and configured to treat collected water;
wherein both the at least one open ditch (2) and the at least one subsurface ditch (3) are connected to the water storage well (1) via the filter pool (5), and a filter chamber (51) is provided in the filter pool (5);
a water level measurement assembly (6), located in the water storage well (1);
a spraying assembly (7), located at one side of the filter pool (5) and connected to the filter pool (5), wherein the spraying assembly (7) is configured to spray a treating agent into the filter chamber (51);
an inflation/suction assembly (8), located at one side of the filter pool (5), wherein one end of the inflation/suction assembly (8) passes through the filter pool (5) and extends into the filter chamber (51), and the inflation/suction assembly (8) is configured to inflate gas into the filter pool (5) or suction a sediment from the filter pool (5); and
a drainage ditch (9), connected to the filter pool (5) at one end and connected to a river channel at the other end.

5. The integrated system for water-adaptive agricultural irrigation in arid regions according to claim 4, wherein, a second control valve (52) is provided between the filter pool (5) and the drainage ditch (9), a third control valve (53) is provided between the filter pool (5) and the water storage well (1);
a water quality detector (54) is provided inside the filter pool (5), and the water quality detector (54) is electrically connected to the second control valve (52), the third control valve (53) and the water level measurement assembly (6) simultaneously.

6. An integrated method for water-adaptive agricultural irrigation in arid regions, which is performed by applying the integrated system for water-adaptive agricultural irrigation in arid regions according to claim 1, comprising:
step 1: collecting water meeting irrigation water quality requirements from a water source within a regional scope, and storing the water in the at least one subsurface ditch and the water storage well, wherein the water source comprises: conventional irrigation water sources selected from surface water and underground water, unconventional water sources selected from rainwater, reclaimed water and mine water, as well as infiltrated irrigation water, drainage water or a mixed water source; and
step 2: taking a critical water requirement threshold during crop growth as a control indicator, monitoring weather, soil and crop growth conditions in real time, and regulating an irrigation based on comprehensive consideration of available water supply, a growth stage of crops and the critical water requirement threshold.

7. The integrated method for water-adaptive agricultural irrigation in arid regions according to claim 6, wherein the irrigation in step 2 is regulated in three modes including a water requirement mode, a suitable water mode and a drainage mode, wherein the irrigation is regulated through the following steps:
step 2.1: monitoring available water supply quantity, Q_{supply}, in the water storage well and the at least one subsurface ditch in real time and determining a relationship between the available water supply quantity and a minimum water requirement quantity, Qₘᵢₙ, and a maximum water requirement quantity, Qₘₐₓ, during crop growth, and
in a case of Q_{supply}<Qₘᵢₙ indicating a water requirement state of the integrated system, regulating the irrigation in the water requirement mode so that external water is supplemented into the water storage well and the at least one subsurface ditch, and irrigating crops with water collected and supplemented in the water storage well and the at least one subsurface ditch timely, wherein Qₛᵤₚₚₗₑₘₑₙₜ is calculated according to Equation 1:
$${Q}_{supplement} = {Q}_{irrigation} - {Q}_{supply} \qquad ( Equation 1 )$$
wherein Qₛᵤₚₚₗₑₘₑₙₜ represents a water quantity to be supplemented, and Q_{irrigation} represents an irrigation water quantity required at the growth stage of crops;
step 2.2: continuously monitoring the available water supply quantity and determining the relationship between the available water supply quantity and the minimum water requirement quantity and the maximum water requirement quantity during the crop growth period, continuously supplementing the external water until Qₘᵢₙ<Q_{supply}<Qₘₐₓ which indicates a suitable water state of the integrated system, regulating the irrigation in the suitable water mode, and irrigating the crops with water collected in the water storage well and the at least one subsurface ditch, without the external water supplemented; and
step 2.3: conducting cyclic irrigation in the suitable water mode, and determining a state of the integrated system in next cycle by monitoring available water supply quantity, Q_{storage} and the growth stage of crops in real time;
in a case of Q_{supply}>Qₘₐₓ and Q_{storage}>Qᵥ indicating a drainage state of the integrated system, regulating the irrigation in the drainage mode so that excess water is drained into a river after treatment,
in a case of the suitable water state of the integrated system, regulating the irrigation in the suitable water mode, and
in a case of the water requirement state of the integrated system, regulating the irrigation in the water requirement mode,
wherein Q_{storage} represents a water quantity stored in the integrated system, and Qᵥ represents a designed volume of the at least one subsurface ditch and the water storage well.

8. The integrated method for water-adaptive agricultural irrigation in arid regions according to claim 7, wherein in step 2.3,
$${Q}_{storage} = {Q}_{rain} + {Q}_{reclaimed} + {Q}_{mine} + {Q}_{infiltration} + {Q}_{supplement} - {Q}_{actual evapotanspiration of crops} - {Q}_{loss} \leq {Q}_{V} \qquad ( Equation 2 )$$
wherein, Qᵣₐᵢₙ represents a stored rainwater quantity, Q_{reclaimed} represents a supplied reclaimed water quantity, Qₘᵢₙₑ represents a supplied mine water quantity, Q_{infiltration} represents a water quantity infiltrated into the at least one subsurface ditch and the water storage well after irrigation, Qₛᵤₚₚₗₑₘₑₙₜ represents a water quantity supplemented from the conventional irrigation water sources, and Q_{actual evapotranspiration of crops} represents actual evapotranspiration of crops, Qₗₒₛₛ represents a water quantity lost during transportation and infiltration, and Qᵥ represents the designed volume of the at least one subsurface ditch and the water storage well.

9. The integrated method for water-adaptive agricultural irrigation in arid regions according to claim 7, wherein the irrigation water quantity, Q_{irrigation}, in step 2.1 is calculated according to Equation 3:
$${Q}_{irrigation} = \{ \begin{matrix}{Q}_{min} + {Q}_{loss} & {Q}_{supply} < {Q}_{min} \\ {Q}_{supply} + {Q}_{loss} & {Q}_{min} < {Q}_{supply} < {Q}_{max} \\ ( {Q}_{min} + {Q}_{loss} , {Q}_{max} + {Q}_{loss} ) & {Q}_{max} < {Q}_{loss}\end{matrix} \qquad ( Equation 3 )$$
wherein, Q_{supply} represents the available water supply quantity in the water storage well and the at least one subsurface ditch, Qₘᵢₙ and Qₘₐₓ represent the minimum water requirement quantity and maximum water requirement quantity during the crop growth period respectively, and Qₗₒₛₛ represents the water quantity lost during transportation and infiltration.

10. The integrated method for water-adaptive agricultural irrigation in arid regions according to claim 7, wherein in step 2.1, the water quantity to be supplemented from the conventional irrigation water source, Qₛᵤₚₚₗₑₘₑₙₜ, is calculated according to the following equations:
$${Q}_{supplement} = max ( {Q}_{estimated crop water requirement} + {Q}_{loss} - {Q}_{storage} , 0 ) \qquad ( Equation 4 )$$
wherein Q_{storage} represents the water quantity stored in the integrated system, Q_{crop requirement} represents an estimated water quantity required for the crop growth, and Qₗₒₛₛ represents the water quantity lost during transportation and infiltration;
$$when {Q}_{estimated crop water requirement} + {Q}_{loss} < {Q}_{storage} , {Q}_{supplement} = 0 ; \qquad ( Equation 5 )$$
during regulation of the irrigation, water source utilization efficiency, η, is calculated according to Equation 6:
$$η = {Q}_{infiltration} / {Q}_{irrigation} \times 100 \% \qquad ( Equation 6 )$$
wherein Q_{infiltration} represents a water quantity infiltrated into the at least one subsurface ditch and the water storage well after irrigation, and Q_{irrigation} represents the irrigation water quantity.

11. An integrated method for water-adaptive agricultural irrigation in arid regions, which is performed by applying the integrated system for water-adaptive agricultural irrigation in arid regions according to claim 2, comprising:
step 1: collecting water meeting irrigation water quality requirements from a water source within a regional scope, and storing the water in the at least one subsurface ditch and the water storage well, wherein the water source comprises: conventional irrigation water sources selected from surface water and underground water, unconventional water sources selected from rainwater, reclaimed water and mine water, as well as infiltrated irrigation water, drainage water or a mixed water source; and
step 2: taking a critical water requirement threshold during crop growth as a control indicator, monitoring weather, soil and crop growth conditions in real time, and regulating an irrigation based on comprehensive consideration of available water supply, a growth stage of crops and the critical water requirement threshold.

12. An integrated method for water-adaptive agricultural irrigation in arid regions, which is performed by applying the integrated system for water-adaptive agricultural irrigation in arid regions according to claim 3, comprising:
step 1: collecting water meeting irrigation water quality requirements from a water source within a regional scope, and storing the water in the at least one subsurface ditch and the water storage well, wherein the water source comprises: conventional irrigation water sources selected from surface water and underground water, unconventional water sources selected from rainwater, reclaimed water and mine water, as well as infiltrated irrigation water, drainage water or a mixed water source; and
step 2: taking a critical water requirement threshold during crop growth as a control indicator, monitoring weather, soil and crop growth conditions in real time, and regulating an irrigation based on comprehensive consideration of available water supply, a growth stage of crops and the critical water requirement threshold.

13. An integrated method for water-adaptive agricultural irrigation in arid regions, which is performed by applying the integrated system for water-adaptive agricultural irrigation in arid regions according to claim 4, comprising:
step 1: collecting water meeting irrigation water quality requirements from a water source within a regional scope, and storing the water in the at least one subsurface ditch and the water storage well, wherein the water source comprises: conventional irrigation water sources selected from surface water and underground water, unconventional water sources selected from rainwater, reclaimed water and mine water, as well as infiltrated irrigation water, drainage water or a mixed water source; and
step 2: taking a critical water requirement threshold during crop growth as a control indicator, monitoring weather, soil and crop growth conditions in real time, and regulating an irrigation based on comprehensive consideration of available water supply, a growth stage of crops and the critical water requirement threshold.

14. An integrated method for water-adaptive agricultural irrigation in arid regions, which is performed by applying the integrated system for water-adaptive agricultural irrigation in arid regions according to claim 5, comprising:
step 1: collecting water meeting irrigation water quality requirements from a water source within a regional scope, and storing the water in the at least one subsurface ditch and the water storage well, wherein the water source comprises: conventional irrigation water sources selected from surface water and underground water, unconventional water sources selected from rainwater, reclaimed water and mine water, as well as infiltrated irrigation water, drainage water or a mixed water source; and
step 2: taking a critical water requirement threshold during crop growth as a control indicator, monitoring weather, soil and crop growth conditions in real time, and regulating an irrigation based on comprehensive consideration of available water supply, a growth stage of crops and the critical water requirement threshold.
